(19) United States
(12) Patent Application Publication
(10) Pub. No.: US 2015/0096755 A1
(43) Pub. Date: Apr. 9, 2015

(54) COMPOSITIONS COMPRISING CARBON DIOXIDE AND REVERSE MICELLES AND METHODS OF USE

(71) Applicant: NEW YORK UNIVERSITY, New York, NY (US)

(72) Inventors: Charles P. Martucci, Scarsdale, NY (US); Iwao Teraoka, Rye, NY (US); Volodymyr Krynytskyy, Brooklyn, NY (US)

(73) Assignee: NEW YORK UNIVERSITY, New York, NY (US)

(21) Appl. No.: 14/509,957

(22) Filed: Oct. 8, 2014

Related U.S. Application Data
(60) Provisional application No. 61/889,005, filed on Oct. 9, 2013.

(51) Int. Cl. C09K 8/594; E21B 43/16

(52) U.S. Cl. CPC C09K 8/594; E21B 43/164
USPC 166/305.1; 507/202

(57) ABSTRACT

Provided herein is a composition comprising carbon dioxide, an aqueous phase, and reverse micelles, wherein the reverse micelles comprise a metal cation-chelating agent, and a metal cation; and methods of using said composition for sequestering carbon dioxide and/or recovering hydrocarbons from a hydrocarbon reservoir.

### CROSS REFERENCE TO RELATED APPLICATIONS

This application claims priority to U.S. Provisional App. No. 61/889,005 filed Oct. 9, 2013, reference of which is incorporated herein in its entirety.

### FIELD OF INVENTION

This invention relates to compositions comprising carbon dioxide an reverse micelles, where the reverse micelles increase the viscosity of the carbon dioxide. This invention further relates to methods of using such compositions for the sequestration of carbon dioxide, where the composition can be stored in a storage vessel or injected underground and stored therein. This invention also relates to methods of using such compositions for “flooding” hydrocarbon reservoirs to enhance the recovery of the hydrocarbons such as crude oil contained therein.

### BACKGROUND

There is a need to develop compositions and methods for sequestering excess carbon dioxide. Removing carbon dioxide from the atmosphere or from a gaseous source requires a very large energy input to overcome the entropic energies associated with isolating and concentrating diffuse gases. Current methods for sequestering carbon dioxide are either inefficient, cost prohibitive, or produce toxic by-products such as chlorine. To lower global carbon dioxide levels, it is critical to develop economically viable compositions and methods to remove vast quantities of carbon dioxide from the atmosphere or gas streams by capturing and sequestering it in a stable form or by converting it to valuable commodity compositions.

In regards to valuable commodity compositions, carbon dioxide might be converted as such if it could somehow be treated to make it more suitable for injection into hydrocarbon reservoir formations and used to increase the recovery of hydrocarbons.

Hydrocarbons such as crude oil occur naturally in reservoir formations mostly as pressurized gasses and liquids. These elevated pressures are a driving mechanism for the primary recovery of hydrocarbons from wells that are drilled into pressurized underground reservoirs. Once the pressure is depleted, a significant portion of the hydrocarbons in the reservoir is left behind with only a fraction of the oil in the ground being produced from primary recovery. Secondary (waterflooding, natural gas reinjection, air injection, carbon dioxide injection) and even tertiary (surfactant, polymer flooding, thermal recovery and in-situ combustion) techniques are used to enhance the hydrocarbon recovery from reservoirs.

Waterflooding is a common secondary recovery technique. Aqueous fluids are injected at one or more points in the reservoir at a pressure sufficient to effect a displacement of the oil from the pores of the reservoir and to push the oil ahead of the water front to the production well or wells. This technique is adequate when the water is available in large quantities, cheap and maintains a high displacement efficiency. Generally, waterflooding by itself has a poor displacement efficiency as a result of the high interfacial tension (IFT) between water and oil. IFT contributes to the capillary retention of the discontinuous oil phase and thereby prevents its displacement. Therefore, chemical additives such as surfactants are used which are wetting agents that lower the interfacial tension between fluids or substances, are added to the water flood to enhance oil recovery. Polymers and alkalines are also used. Surfactant-based techniques are typically categorized as a tertiary recovery method to distinguish it from the usual waterflooding.

Gasflooding is another common recovery technique. Gasflooding includes steam injection, carbon dioxide (CO₂), such as dense phase (i.e., supercritical) carbon dioxide and/or nitrogen gas flooding to increase the mobility of remaining oil. Carbon dioxide flooding, for example, has proven to be among the most promising enhanced oil recovery methods for the United States because it takes advantage of plentiful, naturally-occurring carbon dioxide. When dense phase carbon dioxide is injected into a reservoir above its minimum miscibility pressure (a miscible flood), the gas acts as a solvent. The carbon dioxide picks up lighter hydrocarbon components, swelling the total volume of oil and reducing the viscosity of the oil so that it flows more easily. When a field has already been waterflooded, a tertiary carbon dioxide flood will normally provide incremental recovery of the original oil in place. When carbon dioxide is used instead of waterflood for secondary recovery, the field can produce significant percentages of the original oil in place.

A drawback to gasflooding hydrocarbon reservoirs with dense phase carbon dioxide is that the viscosity of dense phase carbon dioxide is generally lower than that of heavy hydrocarbons such as those in most crude oils. Consequently, dense phase carbon dioxide is relatively immiscible with the heavier components of crude oil and poorly suited for solvating these hydrocarbons. Efforts have been undertaken to treat the carbon dioxide to make it more suitable for injection into hydrocarbon reservoir formations where it can be used to increase the recovery of hydrocarbons.

Because some fluorinated surfactants are soluble in supercritical carbon dioxide, these compounds have been added to dense phase carbon dioxide to increase its viscosity and render the carbon dioxide, in turn, more capable of solvating the crude oil and extracting it from a reservoir. However, fluorinated surfactants are prohibitively expensive and persist in the environment. Unfortunately, because non-fluorinated surfactants are generally insoluble or poorly soluble in supercritical carbon dioxide, these non-fluorinated surfactants generally fail to combine with carbon dioxide or increase the viscosity of carbon dioxide unless the surfactant has multiple hydrophobic tails.

Thus there is a need to develop formulations that render surfactants, such as non-fluorinated surfactants, at least partially miscible in carbon dioxide to render the carbon dioxide more viscous and thus more capable of solvating the crude oil to enhance its recovery from reservoirs.

### SUMMARY OF INVENTION

This invention arises, in part, out of the surprising result that compositions comprising carbon dioxide and a surfactant, where the surfactant itself is relatively immiscible in the carbon dioxide can be formulated with a sufficient quantity of one or more metal cations that cause the surfactant to aggregate into reverse micelles that become at least partially miscible in the carbon dioxide. The formation of these reverse micelles in carbon dioxide increases the viscosity of the carbon dioxide, such as liquid and/or supercritical carbon dioxide and/or aqueous solutions comprising dissolved carbon dioxide. Such compositions comprising reverse micelles and a viscous form of carbon dioxide can be used to sequester carbon dioxide and/or enhance the recovery of hydrocarbons from hydrocarbon reservoirs.

In various aspects, provided herein is a composition comprising carbon dioxide, an aqueous phase, and reverse micelles, wherein the reverse micelles comprise a metal cation-chelating agent, and a metal cation.

In one embodiment, the metal cation-chelating agent consists essentially of one or more polar head groups and a single lipophilic tail. In some embodiments, each of the one or more polar head group refers to a heteroatom-comprising moiety on the molecule that serves to chelate the metal cation. In some embodiments, the single lipophilic tail refers to a saturated or unsaturated C₆-C₂₂ alkane, C₆-C₂₂ alkene or C₆-C₂₂ alkyne, optionally substituted with one or more C₁-C₅ alkane, or preferably C₁-C₃ alkane substituents, and/or —CO₂—C₁-C₃ alkane, O—C₁-C₃ alkane, —N(C₁-C₃ alkane)-, —N(C₁-C₃ alkane)₂-S—C₁-C₃ alkane, wherein the single lipophilic tail may be interrupted with one or more heteroatoms such as —O— or —S— atoms.

In some embodiments, the metal cation-chelating agent is a non-fluorinated metal cation-chelating agent. In some embodiments, the metal cation has a charge of ²⁺ or ³⁺ each of which complexes with multiple metal cation-chelating agents to form reverse micelles in the presence of carbon dioxide.

In another aspect, a method is provided for increasing the viscosity of carbon dioxide comprising contacting the carbon dioxide with a composition comprising water, a metal cation-chelating agent, and a metal cation wherein the composition forms reverse micelles in the carbon dioxide. In some embodiments, the reverse micelles are at least partially miscible in the carbon dioxide.

In another aspect, a method is provided for sequestering carbon dioxide comprising contacting the carbon dioxide with a composition comprising water, a metal cation-chelating agent, and a metal cation wherein the composition forms reverse micelles in the carbon dioxide; and containing the contacted carbon dioxide comprising reverse micelles underground or beneath the sea floor.

In another aspect, a method is provided for recovering hydrocarbons from a hydrocarbon reservoir, comprising: injecting a composition into the hydrocarbon reservoir such that the composition contacts the hydrocarbons therein; and extracting the composition from the hydrocarbon reservoir wherein the extracted composition comprises or comingles with hydrocarbons from the hydrocarbon reservoir and the injected composition comprises carbon dioxide, an aqueous phase, and reverse micelles, wherein the reverse micelles comprise a metal cation-chelating agent, and a metal cation.

### DETAILED DESCRIPTION OF THE INVENTION

It is to be understood that this invention is not limited to particular embodiments described. It is also to be understood that the terminology used herein is for the purpose of describing particular embodiments only, and is not intended to be limiting, since the scope of the present invention will be limited only by the appended claims.

It must be noted that as used herein and in the appended claims, the singular forms “a”, “an”, and “the” include plural referents unless the context clearly dictates otherwise. Thus, for example, reference to “a solvent” includes a plurality of such solvents.

### DEFINITIONS

Unless defined otherwise, all technical and scientific terms used herein have the same meaning as commonly understood by one of ordinary skill in the art to which this invention belongs. As used herein the following terms have the following meanings.

As used herein, the term “comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition or process consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques. The term “about” when used before a numerical designation, e.g., temperature, time, amount, and concentration, including range, indicates approximations which may vary by (+) or (−) 10%, 5% or 1%.

As used herein, the term “water” can include, for example, a brine, a connate water, surface water, distilled water, carbonated water, sea water and a combination thereof.

As used herein, the term “aqueous phase” can include the water, as defined herein, injected into the oil containing reservoir and other fluids and/or compounds already present in the oil containing reservoir.

The term “salt” refers to an ionic compound formed between an acid and a base. When the compound provided herein contains an acidic functionality, such salts include, without limitation, alkali metal, alkaline earth metal, and ammonium salts. As used herein, ammonium salts include, salts containing protonated nitrogen bases and alkylated nitrogen bases. Exemplary, and non-limiting cations useful in pharmaceutically acceptable salts include Na, K, Rb, Cs, NH₄, Ca, Ba, imidazolium, and ammonium cations based on naturally occurring amino acids. When the compounds provided and/or utilized herein contain basic functionality, such salts include, without limitation, salts of organic acids, such as carboxylic acids and sulfonic acids, and mineral acids, such as hydrogen halides, sulfuric acid, phosphoric acid, and the likes. Exemplary and non-limiting anions include acetate, propionate, succinate, chloride, sulfate, bisulfate, mono-, di-, and tribasic phosphate, and the likes.

As used herein, the term “hydrocarbon” refers to oil-bearing products such as petroleum or crude oil, extra-heavy petroleum or oil, asphaltenic sands, oil shales and gases present in geological formations beneath the earth's surface, referred to herein as a hydrocarbon-containing reservoir. The term “oil” refers to a naturally occurring liquid consisting of a complex mixture of hydrocarbons of various molecular weights and structures, and other organic compounds, which are found in geological formations beneath the earth's surface, referred to herein as an oil-containing reservoir.

As used herein, the term “production fluid” refers to the fluid recovered in a production well after sweep of an underground formation with, for example, the compositions disclosed herein. This fluid comprises, in variable proportions, the hydrocarbons extracted from the pores of the underground formation and may further include the composition disclosed here, components thereof, water or brine, etc.

### Compositions

This invention relates to compositions for increasing the viscosity of carbon dioxide such as carbon dioxide existing at least partially in a liquid and/or supercritical state (i.e., condensed phase) or of aqueous solutions consisting essentially of carbon dioxide. In certain aspects, this invention relates to a composition comprising an aqueous phase, carbon dioxide, and reverse micelles, wherein the reverse micelles comprise a metal cation-chelating agent, and a metal cation. Such disclosed compositions are occasionally referred to herein as “compositions comprising carbon dioxide and reverse micelles.” It has been discovered that compositions comprising carbon dioxide and reverse micelles, as disclosed herein, are generally more viscous than carbon dioxide alone or aqueous solutions comprising carbon dioxide. As such, these relatively viscous forms of carbon dioxide comprising reverse micelles can be used advantageously in numerous applications such as e.g., the sequestration of carbon dioxide, where the composition can be stored in a storage vessel or injected underground and stored therein.

Alternatively, the compositions comprising carbon dioxide and reverse micelles can be used to “flood” hydrocarbon reservoirs to enhance the recovery of the hydrocarbons such as crude oil contained therein. Such “flooding” can be achieved by injecting the compositions comprising carbon dioxide and reverse micelles into the hydrocarbon reservoirs to increase the mobility of crude oil therein and thereby force the crude oil from the reservoirs to the surface. In some embodiments, the compositions comprising carbon dioxide and reverse micelles, once injected into the hydrocarbon reservoirs, may lose at least some of the carbon dioxide and absorb hydrocarbons from the hydrocarbon reservoirs. In some embodiments, the compositions comprising carbon dioxide and reverse micelles, once injected into the hydrocarbon reservoirs, are contacted with acid, lose at least some of the carbon dioxide and absorb hydrocarbons from the hydrocarbon reservoirs.

In some embodiments of the composition, the reverse micelles are at least partially miscible in the carbon dioxide. Without being bound by theory, it is contemplated that the hydrophobic tails on the periphery, or outer surface, of the reverse micelles, as opposed to the hydrophilic head groups at their central cores, are at least partially miscible in the carbon dioxide and thereby increase the viscosity of the composition relative to that of carbon dioxide alone.

The compositions described herein may comprise carbon dioxide in any one or more of four distinct phases, a solid, liquid, gas, and/or supercritical fluid, depending upon the temperature and pressure of the composition. In some embodiments of the compositions described herein, the carbon dioxide composition comprises supercritical carbon dioxide. A supercritical fluid is a defined herein as the state of carbon dioxide or a mixture thereof above its critical pressure and critical temperature. The supercritical carbon dioxide-comprising fluid may behave as a liquid with respect to density, while behaving like a vapor with respect to viscosity. Carbon dioxide as a supercritical fluid is stable above a critical pressure of 6.9 megapascal (MPa) and a critical temperature of 31° C. In some embodiments, the carbon dioxide can be in a fluid state either as a liquid and/or as a supercritical fluid and can vacillate between a supercritical phase and a liquid phase depending on the temperature. In some embodiments of the compositions described herein, the carbon dioxide composition comprises an aqueous solution of carbon dioxide.

In some embodiments, the composition comprises about 5 wt %, 10 wt %, 30 wt %, 40 wt %, 50 wt %, 60 wt %, 70 wt %, 80 wt %, 90 wt %, 95 wt %, 99.9 wt %, or a value between any two of these percentages, of carbon dioxide relative to the weight of the composition.

The compositions comprising carbon dioxide, as described herein, can be provided into a hydrocarbon reservoir via one or more injection wells, e.g., wellbores. Carbon dioxide is much less viscous than hydrocarbons such as crude oil and thus these two substances are in general not particularly miscible which may lower the effectiveness by which the injected carbon dioxide comingles with the crude oil and flushes it from the formation.

In certain embodiments, the compositions described herein comprising carbon dioxide and reverse micelles are more viscous (e.g., by 5%, 10%, 25%, 50%, 100%, 2×, 5×, 10×, 20× 100×, 1,000×, 10,000× 100,000× or by a factor between any two of these amounts) than carbon dioxide alone or as an aqueous solution. Without being bound by theory, it is anticipated that the compositions described herein form micelles in carbon dioxide which cause the carbon dioxide to become more viscous and better suited to comingle with hydrocarbons of a viscous crude oil. Further, any of the components of the compositions described herein, e.g., the carbon dioxide, aqueous phase, the reverse micelles, metal cation-chelating agent, and/or metal cation can be varied to adjust the viscosity of the resulting compositions to better match the viscosity of the crude oil and render the compositions more miscible with the crude oil.

In some embodiments of the composition, the reverse micelles are at least partially miscible in hydrocarbons in a hydrocarbon reservoir. In some embodiments, the composition is at least partially miscible at pressures of about 100 kPa to about 100,000 kPa and/or temperatures of about 25° C. to about 150° C.

In some embodiments, the reverse micelles comprise worm-like structures, thread-like structures and/or rod-like structures. Without being bound by theory, it is contemplated that the worm-like, thread-like, and/or rod-like structures of the micelles become entangled in carbon dioxide, such as supercritical carbon dioxide, and thereby increase the viscosity of the carbon dioxide.

In a preferred aspect, the compositions described herein are prepared in situ at an underground location or beneath the sea floor. Thus, the carbon dioxide is injected as a supercritical fluid at a relatively low viscosity into an underground location or beneath the sea floor. Subsequently or concurrently, as the carbon dioxide is being injected or as it is being stored underground, the carbon dioxide is contacted with a mixture comprising water, a metal cation-chelating agent, and a metal cation (each of the metal cation-chelating agent and a metal cation independently at e.g., 10 ppm, 100 ppm, 10,000 ppm or a concentration between these values) where the composition forms reverse micelles in situ with the supercritical carbon dioxide and increases the viscosity of the carbon dioxide while underground, beneath the sea floor or within a hydrocarbon reservoir.

In another preferred embodiment, the compositions described herein are thixotropic, meaning they exhibit relatively low viscosities at relatively high flow rates and they exhibit relatively high viscosities at relatively low flow rates or when the compositions are not moving. Such compositions e.g., gels or fluids, are thick (viscous) under static conditions but will flow (become thin, less viscous) over time when shaken, agitated, or otherwise stressed. Thus, in other preferred embodiments, carbon dioxide is combined with the mixture comprising water, the metal cation-chelating agent, and the metal cation, to form a thixotropic composition, before the resulting composition is injected into an underground location or beneath the sea floor, including a hydrocarbon reservoir. Once combined, the thixotropic composition comprising carbon dioxide, water, the metal cation-chelating agent, and the metal cation (i.e., having reverse micelles) is stirred, mixed or otherwise agitated to maintain a reduced viscosity. The thixotropic composition is subsequently injected into an underground location or beneath the sea floor where it settles into a more viscous gel-like state that prevents the composition, in part, from escaping from its subterranean location.

In some embodiments, the metal cation-chelating agent is a non-fluorinated metal cation-chelating agent. In some embodiments, the metal cation-chelating agent consists essentially of one or more polar head groups and one hydrophilic tail.

In some embodiments, the metal cation-chelating agent is
a compound of Formula I

R¹—CO—NR²R³ Formula I
or a salt thereof, wherein
R¹ is a saturated or unsaturated C₆-C₂₂ alkane, C₆-C₂₂ alkene or C₆-C₂₂ alkyne, or any other organic moiety, and R² and R³ are independently C₁-C₂₀ alkylene substituted with one or more substituents selected from —CO₂H, OH, NH and SH and/or interrupted with one or more —O— atoms.

In some embodiments, R¹ is a saturated or unsaturated C₆-C₂₂ alkane. In some embodiments, R¹ is a saturated or unsaturated C₆-C₂₂ alkene. In some embodiments, R¹ is a saturated or unsaturated C₆-C₂₂ alkyne.

In some embodiments, R² and R³ are independently hydrogen, methylene, ethylene, propylene, butylene, pentylene, or hexylene, each substituted with at least one —CO₂H. In some embodiments, R² and R³ are independently methylene, ethylene, propylene, butylene, pentylene, or hexylene, each substituted with at least one OH. In some embodiments, R² and R³ are independently methylene, ethylene, propylene, butylene, pentylene, or hexylene, each substituted with at least one NH₂. In some embodiments, R² and R³ are independently methylene, ethylene, propylene, butylene, pentylene, or hexylene, each substituted with at least one SH. In some embodiments, NR²R³ is N(CH₂CH₂OH)₂. In some embodiments, —NR²R³ is NHR³. In some embodiments, —NR²R³ is protonated as —NH(H+)R²R³. In some embodiments, NR²R³ is N[(CH₂CH₂O)ₙ(CH₂CH₂OH)]₂, wherein n is 1, 2, 3, 4, 5, 6 7, 8, 9, or 10.

In some embodiments, R¹—CO—NR²R³ is protonated, e.g., as R¹—CO—N(H+)R²R³.

In some embodiments, the compound of Formula I is cocamide diethylamine:

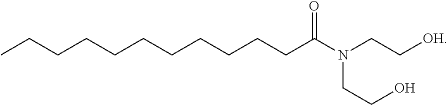 [SMILES: CCCCCCCCCCCC(=O)N(CCO)CCO]

In some embodiments, the R¹—CO— moiety of the R¹—CO—NR²R³ amide derives from a R¹—COOH fatty acid that is selected from the group consisting of lauric acid, myristic acid, palmitic acid, stearic acid, myristoleic acid, oleic acid, palmitoleic acid, (trans) vaccenic acid, hexadecatrienoic acid, linoleic acid, α-linolenic acid, β-linolenic acid, γ-linolenic acid, stearidonic acid, eicosatrienoic acid, eicosatetraenoic acid, eicosapentenoic acid, heneicosapentenoic acid, docosapentenoic acid, docosahexaenoic acid, tetracosapentenoic acid, tetracosahexaenoic acid, sapienic acid, elaidic acid, linoelaidic acid, α-eleostearic acid, β-eleostearic acid, arachidonic acid, erucic acid and combinations thereof.

In some embodiments, the metal cation-chelating agent is
a compound of Formula II

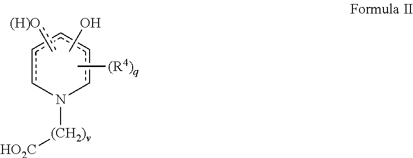

or a salt or tautomer thereof, wherein
R⁴ is C₁-C₆ alkyl, C₂-C₆ alkenyl, OR⁵, SR⁵, NR⁵R⁶ or —CO₂R⁵, wherein R⁵ and R⁶ are independently hydrogen or C₁-C₆ alkyl;
[symbol] is a single or double bond;
(H) is present if [symbol] is a single and (H) is absent if [symbol] is a double bond;
q is 0, 1, 2 or 3; and
v is 1 to 22.

In some embodiments, R⁴ is C₁-C₆ alkyl. In some embodiments, R⁴ is C₂-C₆ alkenyl. In some embodiments, R⁴ is OR⁵. In some embodiments, R⁴ is SR⁵. In some embodiments, R⁴ is NR⁵R⁶. In some embodiments, R⁴ is —CO₂R⁵. In some embodiments, R⁵ and R⁶ are hydrogen. In some embodiments, R⁵ and R⁶ are C₁-C₆ alkyl. In some embodiments, R⁵ and R⁶ are methyl.

In some embodiments, q is 0. In some embodiments, q is 1. In some embodiments, q is 2. In some embodiments, q is 3.

In some embodiments, v is 1. In some embodiments, v is 2. In some embodiments, v is 3. In some embodiments, v is 4. In some embodiments, v is 5. In some embodiments, v is 6. In some embodiments, v is 7. In some embodiments, v is 8. In some embodiments, v is 9. In some embodiments, v is 10. In some embodiments, v is 11. In some embodiments, v is 12. In some embodiments, v is 13. In some embodiments, v is 14. In some embodiments, v is 15. In some embodiments, v is 16. In some embodiments, v is 17. In some embodiments, v is 18. In some embodiments, v is 19. In some embodiments, v is 20. In some embodiments, v is 21. In some embodiments, v is 22.

In some embodiments, the compound of Formula II is a compound of Formula III

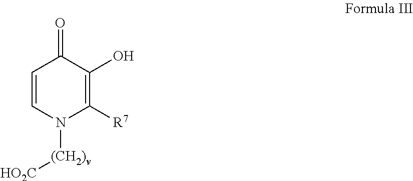

or a salt or tautomer thereof, wherein R⁷ is C₁-C₆ alkyl and v is 1 to 22.

In some embodiments, R⁷ is methyl. In some embodiments, R⁷ is ethyl. In some embodiments, R⁷ is propyl. In some embodiments, R⁷ is butyl.

In some embodiments, v is 1. In some embodiments, v is 2. In some embodiments, v is 3. In some embodiments, v is 4. In some embodiments, v is 5. In some embodiments, v is 6. In some embodiments, v is 7. In some embodiments, v is 8. In some embodiments, v is 9. In some embodiments, v is 10. In some embodiments, v is 11. In some embodiments, v is 12. In some embodiments, v is 13. In some embodiments, v is 14. In some embodiments, v is 15. In some embodiments, v is 16. In some embodiments, v is 17. In some embodiments, v is 18. In some embodiments, v is 19. In some embodiments, v is 20. In some embodiments, v is 21. In some embodiments, v is 22.

In some embodiments of the composition, the metal cation-chelating agent is present in the composition in a concentration of about 1 nM to about 10 M. In some embodiments, the metal cation-chelating agent is present in the composition in a concentration of about 1 nM, 100 nM, 1,000 nM, 1 M, 10 M or a concentration between any two of those listed.

In some embodiments of the composition, the metal cation-chelating agent is present in the composition in a concentration of about 1 ppm to about 10,000 ppm. In some embodiments, the metal is present in the composition in a concentration of about 1 ppm, 100 ppm, 1,000 ppm, 10,000 ppm or a concentration between any two of those listed.

In some embodiments, the metal cation has a charge of ²⁺, ³⁺, or ⁴⁺. In some embodiments, the metal cation is Na⁺, Li⁺, K⁺, Ag⁺, Cu⁺, Ca²⁺, Ba⁺², Cr⁺², Cu⁺², Fe⁺², Pb⁺², Mn⁺², Zn⁺², Sr⁺², Cr⁺³, Al⁺³, Fe⁺³, Mn⁺³, Sn⁺⁴ and combinations thereof. In some embodiments, the metal cation has a charge of ²⁺. In some embodiments, the metal cation has a charge of ⁴⁺. In some embodiments, the metal cation has a charge of ⁴⁺. In some embodiments, the metal cation is Al⁺³. In some embodiments, the metal cation is Fe⁺³.

In some embodiments of the composition, the metal cation is present in the composition in a concentration of about 1 nM to about 10 M. In some embodiments, the metal is present in the composition in a concentration of about 1 nM, 100 nM, 1,000 nM, 1 M, 10 M or a concentration between any two of those listed.

In some embodiments of the composition, the metal cation is present in the composition in a concentration of about 1 ppm to about 10,000 ppm. In some embodiments, the metal is present in the composition in a concentration of about 1 ppm, 100 ppm, 1,000 ppm, 10,000 ppm or a concentration between any two of those listed.

In some embodiments, the composition comprises a molar ratio of metal cation to metal cation-chelating agent of about 1:1,000 to about 1,000:1. In some embodiments, the composition comprises a molar ratio of metal cation to metal cation-chelating agent of about 1:1,000, 1:100, 1:10, 1:1, 10:1, 100:1, 1,000:1 or a ratio between any two of those listed.

In some embodiments of the composition, the aqueous phase comprises water and the composition comprises a molar ratio of water to metal cation-chelating agent of about 1:10 to about 1000:1.

In some embodiments of the composition, the aqueous phase comprises water and the composition comprises a molar ratio of water to metal cation-chelating agent of about 1:1,000 to about 1,000:1. In some embodiments, the aqueous phase comprises water and the composition comprises a molar ratio of water to metal cation-chelating agent of about 1:1,000, 1:100, 1:10, 1:1, 10:1, 100:1, 1,000:1 or a ratio between any two of those listed.

In some embodiments, the aqueous phase comprises NaCl. In some embodiments, the aqueous phase comprises brine. In some embodiments, the aqueous phase comprises seawater.

In some embodiments, the composition has a density >1. In some embodiments, the composition has a density of about 1.5, 2, 3, 4, 5, 6, 7, 8, 9, 10, 11, 12, 13, 14, 15 or a density between any two of those listed.

In some embodiments, the composition has a viscosity at 20° C. of about 1 mPa·s to about 5,000 Pa·s. In some embodiments, the composition has a viscosity at 20° C. of greater than 1 mPa·s. In some embodiments, the composition has a viscosity at 20° C. of about 1 mPa·s, 10 mPa·s, 100 mPa·s, 1,000 mPa·s, 1,500 mPa·s, 5,000 mPa·s, or a viscosity between any two of these values.

In some embodiments, the composition further comprises an additive such as a surfactant, alcohol, solvent, polymer, oxygen scavenger, corrosion inhibitor, scale inhibitor or combination thereof, wherein each of these additives is selected from those that are commonly known to the skilled artisan. In some embodiments, the total amount of the additives added to the compositions described herein is not greater than about 5, 10 or 15 weight percent, based on a total weight of the composition.

Surfactant additives generally refer to organic compounds that are amphiphilic, meaning they contain both hydrophobic groups (alkylated phenol derivatives, fatty acids, linear or branched aliphatic alcohol, long-chain linear alcohols, etc.) and hydrophilic groups (generally derived from ethylene oxide, propylene oxide and/or butylene oxide and having various lengths). Surfactant additives are not selected from the metal cation-chelating agents disclosed herein.

Examples of surfactant additives for use with the compositions described herein include, but are not limited to, exthoxylated aliphatic alcohols, polyoxyethylene, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, branched alkylphenoi alkoxylates, linear alkylphenol alkoxylates, and branched alkyl alkoxylates, and combinations thereof.

Examples of alcohol additives for use with the compositions described herein include, but are not limited to, isopropanol, diethyleneglycol monobutyl ether, ethyleneglycol monobutyl ether, diethylene glycol monoethyl ether, ethyleneglycol monobutylether, ethyleneglycol monopropylether, dipropyleneglycol monomethyl ether, dipropyleneglycol monobutyl ether, propylene glycol monomethyl ether, propyleneglycol monopropyl ether, propyleneglycol monobutyl ether, butyl acetate, propyleneglycol, ethyleneglycol, and combinations thereof.

Examples of polymer additives for use with the compositions described herein include, but are not limited to, carbon dioxide-soluble polymers such as poly(vinyl acetate), polypropylene glycol, and poly(lactic acid). Other polymers include polyacrylamides, partially hydrolyzed polyacrylamide, polyacrylates, ethylenic copolymers, biopolymers, polyvinyl alcohol, polystyrene sulfonates, polyvinylpyrrolidone, AMPS (2-acrylamide-2-methyl propane sulfonate) or combinations thereof. The molecular mass of the polymer additive may be about 10,000, 500,000 and 10,000,000 g/mol or a molecular mass between these values.

### Methods of Use

In another aspect, a method is provided for increasing the viscosity of a composition comprising carbon dioxide comprising contacting the carbon dioxide with water, a metal cation-chelating agent, and a metal cation (each of the metal cation-chelating agent and a metal cation independently at e.g., 10 ppm, 100 ppm, 10,000 ppm or a concentration between these values) wherein the composition forms reverse micelles in the carbon dioxide. In some embodiments, the reverse micelles are at least partially miscible in the carbon dioxide. In some embodiments, the method further comprises adjusting the amount of water and/or the concentration of metal cation-chelating agent and/or the metal cation that is added to the carbon dioxide to further increase or decrease the viscosity of the composition comprising carbon dioxide.

In another aspect, a method is provided for sequestering carbon dioxide comprising contacting the carbon dioxide with a composition comprising water, a metal cation-chelating agent, and a metal cation (each of the metal cation-chelating agent and a metal cation independently at e.g., 10 ppm, 100 ppm, 10,000 ppm or a concentration between these values) wherein the composition forms reverse micelles in the carbon dioxide and increases the viscosity of the carbon dioxide; and storing the contacted carbon dioxide comprising reverse micelles underground or beneath the sea floor.

In a preferred embodiment, carbon dioxide having a relatively low viscosity is injected into a location underground or beneath the sea floor and a mixture comprising water, the metal cation-chelating agent, and the metal cation are added in situ to the flow of carbon dioxide either after the carbon dioxide has been injected or during the injection process, thereby forming reverse micelles and increasing the viscosity of the resulting composition. This in situ addition of water, the metal cation-chelating agent, and the metal cation to the carbon dioxide allows the carbon dioxide to be injected, or partially injected, at a relatively low viscosity before it comingles with the reverse micelles, becomes more viscous and “sets” or gels its place of storage, which prevents the composition, in part, from escaping from its subterranean location.

In some preferred embodiments, the compositions described herein are thixotropic, meaning they exhibit relatively low viscosities at relatively high flow rates and they exhibit relatively high viscosities at relatively low flow rates or when the compositions are not moving. Such compositions e.g., gels or fluids, are thick (viscous) under static conditions but will flow (become thin, less viscous) over time when shaken, agitated, or otherwise stressed. Thus, in other preferred embodiments, carbon dioxide is combined with the mixture comprising water, the metal cation-chelating agent, and the metal cation, to form a thixotropic composition, before the resulting composition is injected into an underground location or beneath the sea floor. Once combined, the thixotropic composition comprising carbon dioxide, water, the metal cation-chelating agent, and the metal cation (i.e., having reverse micelles) is stirred, mixed or otherwise agitated to maintain a reduced viscosity. The thixotropic composition is subsequently injected into an underground location or beneath the sea floor where it settles into a more viscous gel-like state that prevents the composition, in part, from escaping from its subterranean location.

In yet another aspect, a method is provided for sequestering carbon dioxide comprising first storing the contacted carbon dioxide comprising reverse micelles underground or beneath the sea floor; and subsequently or concurrently contacting the carbon dioxide, as it is being injected or stored, or after it has already been stored, with a composition comprising water, a metal cation-chelating agent, and a metal cation (each of the metal cation-chelating agent and a metal cation independently at e.g., 10 ppm, 100 ppm, 10,000 ppm or a concentration between these values) wherein the composition forms reverse micelles in situ in the carbon dioxide and increases the viscosity of the carbon dioxide while underground or beneath the sea floor.

In some embodiments, the method comprises storing the composition comprising reverse micelles and carbon dioxide in geological structures, particularly in depleted natural gas fields. In some embodiments, the method comprises storing the composition comprising reverse micelles and carbon dioxide in deep saline reservoirs, such as those located in the oceans.

The compositions and methods described herein can be used to sequester a virtually continuous supply of carbon dioxide as the reverse micelles are easily formed from inexpensive starting materials. The compositions and methods disclosed herein provide an inexpensive means for reducing atmospheric levels of carbon dioxide by increasing the viscosity of supercritical carbon dioxide and storing the resulting gel underground or beneath the sea floor. This viscous (e.g., gelatinous) form of carbon dioxide comprising the micelles is easier to contain than conventional forms of carbon dioxide such as supercritical or gaseous carbon dioxide.

Aspects of the present invention also provide methods for enhanced oil recovery processes. Such methods may include introducing (e.g., injecting) water, a metal cation-chelating agent, and a metal cation (each of the metal cation-chelating agent and a metal cation independently at e.g., 10 ppm, 100 ppm, 10,000 ppm or a concentration between these values) into a flow of carbon dioxide (e.g., liquid and/or supercritical carbon dioxide) being injected into a hydrocarbon containing reservoir, where the water, metal cation-chelating agent, metal cation and carbon dioxide form reverse micelles.

Once injected into the hydrocarbon containing reservoir, the composition contacts the hydrocarbons therein, and optionally sheds a first weigh percentage (e.g., 10 wt %, 20 wt %, 50 wt %, 75 wt %, 100 wt % or a percentage between any two of these values) of the original carbon dioxide in the composition. Once injected into the hydrocarbon containing reservoir, the composition at least partially comingles with the hydrocarbons and thereby reduces (e.g., by 10%, 20%, 50%, 75%, or a percentage between any two of these values) the viscosity of the hydrocarbons to facilitate their extraction from the reservoir. Thus, in some embodiments, the composition and comingled hydrocarbons are extracted from the reservoir.

In some embodiments, the method further comprises contacting the composition with acid, such as hydrochloric acid, after the composition is injected into the hydrocarbon reservoir.

In some embodiments, the method further comprises substantially separating the hydrocarbons from the extracted composition to form a separated composition that is substantially free of hydrocarbons. In some embodiments, the method still further comprises contacting carbon dioxide with the separated composition to form a recycled composition comprising carbon dioxide. In some embodiments, the method further comprises injecting the recycled composition comprising carbon dioxide into the hydrocarbon reservoir.

In a preferred embodiment of the method, carbon dioxide having a relatively low viscosity is injected into the hydrocarbon containing reservoir and a mixture comprising water, the metal cation-chelating agent, and the metal cation are added in situ to the flow of carbon dioxide either after the carbon dioxide has been injected or during the injection process, thereby forming reverse micelles and increasing the viscosity of the resulting composition. This in situ addition of water, the metal cation-chelating agent, and the metal cation to the carbon dioxide allows the carbon dioxide to be injected, or partially injected, at a relatively low viscosity before it comingles with the reverse micelles, becomes more viscous and “sets” or gels in the hydrocarbon containing reservoir, unless it begins to flow through the hydrocarbon containing reservoir.

In some preferred embodiments, the compositions described herein are thixotropic. Thus, in other preferred embodiments, carbon dioxide is combined with the mixture comprising water, the metal cation-chelating agent, and the metal cation, to form a thixotropic composition, before the resulting composition is injected into the hydrocarbon containing reservoir. Once combined, the thixotropic composition comprising carbon dioxide, water, the metal cation-chelating agent, and the metal cation (i.e., having reverse micelles) is stirred, mixed or otherwise agitated to maintain a reduced viscosity. The thixotropic composition is subsequently injected into the hydrocarbon containing reservoir where it settles into a more viscous gel-like state, unless it begins to flow through the hydrocarbon containing reservoir.

In other aspects, a method is provided for the removal of carbon dioxide from the atmosphere by contacting the carbon dioxide with a composition comprising water, a metal cation-chelating agent, and a metal cation (each of the metal cation-chelating agent and a metal cation independently at e.g., 10 ppm, 100 ppm, 10,000 ppm or a concentration between these values) wherein the composition forms reverse micelles in the carbon dioxide; and storing the contacted carbon dioxide and the composition underground or beneath the sea floor.

In an additional embodiment of any of the methods described herein, the compositions may be injected or delivered to an underground location or beneath the sea floor (e.g., depleted natural gas fields, subterranean saline reservoirs or hydrocarbon reservoirs, etc.) via one or more injection lines or downhole pipes. In one embodiment, a single injection line is used to deliver the composition.

### Apparatus

Aspects of the present invention also provide an apparatus for injecting a composition comprising carbon dioxide and reverse micelles underground or beneath the sea floor, where the composition comprises water, a metal cation-chelating agent, and a metal cation, and the apparatus comprises a pump and pumping system for injecting the composition, particularly a composition comprising dense phase carbon dioxide. In some embodiments, the apparatus is configured to inject the composition comprising dense phase carbon dioxide into geological structures, particularly in depleted natural gas fields, deep saline reservoirs, or an oil and/or gas reservoir. In some embodiments, the apparatus is configured to pump greenhouse gases such as methane, nitrous oxide, or chlorofluorocarbons that can exist in a dense phase and dispose of the gases underground or underwater as applicable. In some embodiments, the apparatus further comprises one or more storage tanks for aqueous solutions or an underground or subsea reservoir in communication with the pump. In some embodiments, the apparatus is configured for the sequestration of the composition comprising carbon dioxide and reverse micelles underground or beneath the sea floor. In other embodiments, the apparatus is configured for the gas injection of the composition comprising carbon dioxide and reverse micelles into a hydrocarbon reservoir to enhance production of the hydrocarbons therein.

### Examples

### Example 1

### Preparation of 1-(11′-carboxydecyl)-3-hydroxy-2-methyl-4-pyridinone and Related Analogs

1-(11′-Carboxydecyl)-3-hydroxy-2-methyl-4-pyridinone was prepared by hydrogenating 3-benzyloxyl-1-11′-carboxydecyl-2-methyl-4-pyridinone, itself prepared according to routine synthetic methods that are known to the skilled artisan. For example, 0.24 g of the 3-benzyloxy precursor was combined in a Parr hydrogenation apparatus with 50 mL of 95% ethanol and 99 mg Pd/C. Following evacuation of the air within the apparatus, hydrogen gas was added at approximately 18 PSI and the mixture was shaken shaking at room temperature for 20 hours, filtered and the filtrate was concentrated and recrystallized from ethanol to yield 0.087 g of 1-(11′-carboxydecyl)-3-hydroxy-2-methyl-4-pyridinone having a melting range of 168-170° C.

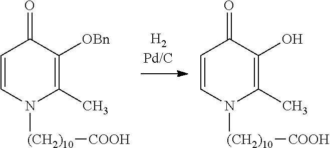

Related analogs such as those shown in the table below were made from known reactions including the hydrogenation of a benzyl-protected precursors as described above.

TABLE 1

| | | | Actual | |
|---|---|---|---|---|
| | | Molecular | weight | Calculated |
| | | Weight | measured | weight |
| Structure | Name | (g/mol) | (g) | (g) |
| 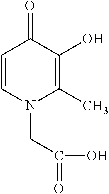 | “C-2” 1- Carboxymethyl- 3-Hydroxy- 2-Methyl-pyrid- 4-one | 183.07 | 0.00191 | 0.00183 |
| 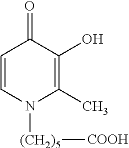 | “C-6” 1-(6′- Carboxypentyl)- 3-Hydroxy-2- Methyl-4- Pyridinone | 239.9 | 0.00250 | 0.00239 |
| 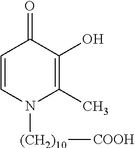 | “C-11” 1-(11′- Carboxydecyl)-3- Hydroxy-2- Methyl-4- Pyridinone | 309.5 | 0.00109 | 0.00309 |
| 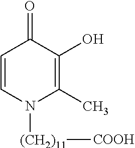 | “C-12” 1-(12′- Carboxyundecyl)- 3-Hydroxy-2- Methyl-4- Pyridinone | 323.5 | 0.00324 | 0.00323 |

### Example 2

### Preparation of Reverse Micelles in Decalin as a Model for Hydrophobic Solvents Such as Crude Oil

Reverse micelles were prepared in decalin (decahydronaphthalene, cis and trans isomers) comprising cocamide diethanolamine (DEA) and a 26.7 wt % solution (having a molar ratio of 1:37) of Fe(NO₃)₃ in water.

Four series of mixtures, each with a common concentration of cocamide DEA but with different amounts of Fe³⁺ were prepared. The four concentrations of cocamide DEA were 0.08, 0.16, 0.24, and 0.32 M. First, a specified amount of cocamide DEA was added to decalin. The mixture was gently shaken to obtain a uniform, clear solution. The solution was slightly yellow. Then, a specified amount of the Fe(NO₃)₃ solution was added, and the mixture was gently shaken. The mixture was left to stand. Some of the mixtures separated into two or three phases. It typically took a day or two for the mixture to reach the equilibrium volume ratio of the multi-phases. The table below summarizes observations of the mixtures after 60-70 days. Each column represents mixtures with a shared cocamide DEA concentration but different concentrations of Fe³⁺. The latter is given as the molar ratio of cocamide DEA to Fe³⁺, listed in the first column.

The following are shown in Table 2 below:
1. Number of phases
2. Volume ratio of the phases (if the mixture has 2 or 3 phases) and the colors of the phases, from the top to bottom of the mixture.
3. The viscosity is noted where it is apparently different from that of decalin or a solution of cocamide DEA at the same concentration.

A red laser pointer was used to observe the scattering of light. Colorless to yellow phases scatter little light. Dark brown phases scatter much light to nearly extinguish the light that travels across the diameter of the vial (˜27 mm). The darker the solution, the stronger was the scattering. The brown color indicated formation of a Fe³⁺-cocamide DEA complex. The strong scattering indicated the presence of structures 10 to 100 nm in size. Gray-shaded boxes indicate single-phase mixtures with noticeably higher viscosities compared with a solution of cocamide DEA. The high viscosity was notable in some of the 0.32 M mixtures. At 0.32 M, the volume fraction of cocamide DEA was 0.094. If the structure of the complex is globular, the viscosity will be only about 23% higher than that of decalin. Furthermore, some of the viscous mixtures showed elasticity and/or appeared to be a gel when shaken a few times, suggesting that wormlike micelles were formed in these samples. Light scattering intensity correlated with the color (colorless-light brown-brown-dark brown). The volume ratios refer to the phases from top to bottom. Bold highlighting indicates a single-phase viscous solution.

TABLE 2

| [Cocamide | Cocamide DEA Concentration | | | |
|---|---|---|---|---|
| DEA]/[Fe3+] | 0.08M | 0.16M | 0.24M | 0.32M |
| 24 | 1 phase; | | | 2 phases; |
| | light yellow | | | 7:1 |
| | | | | light brown:brown |
| 19 | | | | 1 phase; |
| | | | | light brown; |
| | | | | some precipitates at the bottom |
| 16 | | | | 1 phase; |
| | | | | brown; |
| | | | | viscous and elastic |
| 15 | | 2 phases; | | |
| | | 1:1 | | |
| | | colorless:brown | | |
| 13 | | | 2 phases; | 1 phase; |
| | | | 1:4 | brown; |
| | | | colorless:brown | viscous and elastic |
| 12 | 2 phases; | 2 phases; | 2 phases; | 1 phase; |
| | 2:1 | 1:1 | 1:5 | brown; |
| | colorless:brown | colorless:brown | colorless:brown | viscous and elastic |
| 10 | | 2 phases; | | 2 phases; |
| | | 2:3 | | 1:1 |
| | | colorless:brown | | colorless:dark brown; |
| | | | | Colorless part is clear; |
| | | | | dark brown part scatters strongly |
| 9 | | | 2 phases; | 3 phases; |
| | | | 1:5 | 1:5:1 |
| | | | light yellow:brown | colorless:brown:dark brown |
| | | | | Yellow part is not viscous |
| 8 | | 3 phases; | 2 phases; | |
| | | 5:4:1 | 2:1 | |
| | | colorless:brown:dark brown | light yellow:brown | |
| 7 | 2 phases; | 2 phases; | | 2 phases; |
| | 10:1 | 5:1 | | 3:2 |
| | light brown:dark brown | light brown:dark brown | | light brown:dark brown; |
| | | | | Light brown part is not viscous |
| 6.5 | 2 phases; | 2 phases; | | 2 phases; |
| | 10:1 | 3:1 | | 1:1 |
| | brown:dark brown | brown:dark brown | | brown:dark brown; |
| | | | | viscous |
| 6 | | | 1 phase | |
| | | | dark brown | |
| 5.5 | | 1 phase | 1 phase | 1 phase |
| | | brown | dark brown | dark brown; |
| | | | | viscous |
| 5 | | | | 1 phase |
| | | | | dark brown; |
| | | | | viscous |
| 4.5 | | 1 phase | | |
| | | brown | | |
| 4 | | | 2 phases; | |
| | | | 50:1 | |
| | | | dark brown:light brown | |
| | | | (precipitate) | |
| 3.6 | 2 phases; | | 2 phases; | |
| | 20:1 | | 50:1 | |
| | brown:dark brown | | dark brown:light brown | |
| | | | (precipitate) | |
| 2.6 | 2 phases; | 2 phases; | | |
| | 20:1 | 50:1 | | |
| | light brown:dark brown | brown:light brown | | |
| | | (precipitate) | | |
| 2 | 2 phases; | | | |
| | 20:1 | | | |
| | light brown:dark brown | | | |
| 1.8 | 2 phases; | 3 phases; | | |
| | 10:1 | 5:2:3 | | |
| | light brown:dark brown | light brown:light | | |
| | | brown:dark brown; | | |
| | | bottom part is viscous | | |
| 1.4 | | 3 phases; | | |
| | | 4:3:3 | | |
| | | light brown:light | | |
| | | brown:dark brown; | | |
| | | bottom part is viscous | | |

### Example 3

### Preparation of Cocamide DEA-Based Micelles Comprising Carbon Dioxide

Cocamide DEA was dissolved in 0.1M MOPS Buffer, pH 7.4, and another solution of freshly prepared Iron (III) ammonium sulfate was added to give a threefold molar excess of Fe³⁺ ion. Then, a change in the color of the solution was noted (clear to red-brown), and confirmed by UV-visible spectroscopy. When carbonated water (seltzer) containing approximately a stoichiometric amount of carbon dioxide was added to the surfactant—Iron (III) solution, almost immediately the solution became highly viscous. Control samples containing MOPS buffer alone or samples of two other types of surfactants (sodium dodecyl sulfate or Triton X-100), when tested separately, did not show a color change or an increase in the viscosity.

### Example 4

### Preparation of 3-hydroxy-2-methyl-pyridinone-based Reverse Micelles Comprising Carbon Dioxide

Surfactant compounds of Table 1 were prepared that contain a 3-hydroxy-2-methyl-pyridine-4-one group with a variable length, N-attached alkyl chain possessing a terminal carboxylic acid group.

These surfactants of Table 1 were found to react with carbon dioxide to provide solutions with viscosities slightly lower than those of the cocamide DEA-based solutions discussed above. Of the compounds with different n, C-11 and C-12 demonstrated the strongest surfactant properties. Therefore, C-11 and C-12 were chosen for more thorough testing for the formation of iron (III) complexes and reverse micelle formation. When C-11 and C-12 were dissolved in pH 7.4, 0.1M MOPS Buffer, and then another solution of freshly prepared iron (III) ammonium sulfate was added, the color changed. Adding seltzer increased the solution viscosity. The color change in these experiments indicates formation of chelates, which help organize these surfactant molecules into wormlike micelles. Entanglement of wormlike micelles was evident from the elevated viscosities of the solutions.

1. A composition comprising:
carbon dioxide, an aqueous phase, and reverse micelles;
wherein the reverse micelles comprise a metal cation-chelating agent, and a metal cation.

2. The composition of claim 1, wherein the reverse micelles are at least partially miscible in the carbon dioxide.

3. The composition of claim 1, wherein the reverse micelles are at least partially miscible in hydrocarbons in a hydrocarbon reservoir.

4. The composition of claim 2, wherein the composition is at least partially miscible at pressures of about 100 kPa to about 100,000 kPa and/or temperatures of about 25° C. to about 150° C.

5. The composition of claim 1, wherein the reverse micelles comprise worm-like structures, thread-like structures and/or rod-like structures.

6. The composition of claim 1, wherein the metal cation-chelating agent is a non-fluorinated metal cation-chelating agent.

7. The composition of claim 1, wherein the metal cation-chelating agent comprises one polar head group and one hydrophilic tail.

8. The composition of claim 1, wherein the metal cation-chelating agent is a compound of Formula I
R¹—CO—NR²R³ Formula I
or a salt thereof, wherein
R¹ is a saturated or unsaturated C₆-C₂₂ alkane, C₆-C₂₂ alkene or C₆-C₂₂ alkyne, or any other organic moiety, and R² and R³ are independently C₁-C₂₀ alkylene substituted with one or more substituents selected from —CO₂H, OH, NH₂ and SH and/or interrupted with one or more —O— atoms.

9. The composition of claim 8, wherein the compound of Formula I is cocamide diethylamine.

10. The composition of claim 1, wherein the metal cation-chelating agent is a compound of Formula II 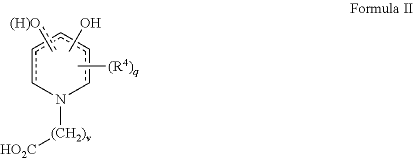
or a salt or tautomer thereof, wherein
R⁴ is C₁-C₆ alkyl, C₂-C₆ alkenyl, OR⁵, SR⁵, NR⁵R⁶ or —CO₂R⁵, wherein R⁵ and R⁶ are independently hydrogen or C₁-C₆ alkyl; [symbol]
is a single or double bond;
(H) is present if [symbol] is a single and (H) is absent if [symbol] is a double bond;
q is 0, 1, 2 or 3; and
v is 1 to 22.

11. The composition of claim 10, wherein the compound of Formula II is a compound of Formula III 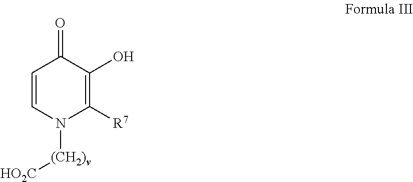
or a salt or tautomer thereof, wherein R⁷ is C₁-C₆ alkyl and v is 1 to 22.

12. The composition of claim 1, wherein the metal cation has a charge of ²⁺, ³⁺, or ⁴⁺.

13. The composition of claim 1, wherein the metal cation is Fe³⁺ or Al³⁺.

14. The composition of claim 1, wherein the carbon dioxide composition comprises supercritical carbon dioxide.

15. The composition of claim 1, comprising about 10 wt % to about 99.9 wt % carbon dioxide relative to the weight of the composition.

16. The composition of claim 1, wherein the metal cation-chelating agent is present in the composition in a concentration of about 1 nM to about 10 M.

17. The composition of claim 1, wherein the metal cation is present in the composition in a concentration of about 1 nM to about 10 M.

18. The composition of claim 1, wherein the composition comprises a molar ratio of metal cation to metal cation-chelating agent of about 1:100 to about 10:1.

19. The composition of claim 1, wherein the aqueous phase comprises water and the composition comprises a molar ratio of water to metal cation-chelating agent of about 1:10 to about 1000:1.

20. The composition of claim 1, wherein the aqueous phase comprises NaCl.

21. The composition of claim 1, wherein the composition has a density >1.

22. The composition of claim 1, wherein the composition has a viscosity at 20° C. of greater than 1 mPa·s.

23. The composition of claim 1, wherein the composition further comprises a surfactant, solvent, polymer, oxygen scavenger, corrosion inhibitor, scale inhibitor or combination thereof.

24. A method for recovering hydrocarbons from a hydrocarbon reservoir, comprising:
injecting the composition of claim 1 into the hydrocarbon reservoir such that the composition contacts the hydrocarbons therein; and
extracting the composition from the hydrocarbon reservoir wherein the extracted composition comprises hydrocarbons from the hydrocarbon reservoir.

25. The method of claim 24, wherein the method further comprises contacting the composition with acid after the composition is injected into the hydrocarbon reservoir.

26. The method of claim 24, wherein the method further comprises substantially separating the hydrocarbons from the extracted composition to form a separated composition substantially free of hydrocarbons.

27. The method of claim 26, wherein the method further comprises contacting carbon dioxide with the separated composition to form a recycled composition comprising carbon dioxide.

28. The method of claim 27, wherein the method further comprises injecting the recycled composition comprising carbon dioxide into the hydrocarbon reservoir.

29. A method for increasing the viscosity of carbon dioxide comprising contacting the carbon dioxide with a composition comprising water, a metal cation-chelating agent, and a metal cation wherein the composition forms reverse micelles in the carbon dioxide.

30. A method for sequestering carbon dioxide comprising
contacting the carbon dioxide with a composition comprising water, a metal cation-chelating agent, and a metal cation wherein the composition forms reverse micelles in the carbon dioxide; and
containing the contacted carbon dioxide comprising reverse micelles underground.

31. The method of claim 30, wherein the contacted carbon dioxide comprising reverse micelles is stored underground.

32. A method for the removal of carbon dioxide from the atmosphere, comprising contacting the carbon dioxide with a composition comprising water, a metal cation-chelating agent, and a metal cation wherein the composition forms reverse micelles in the carbon dioxide; and storing the contacted carbon dioxide and the composition underground or beneath the sea floor.
